(19) United States
(12) Patent Application Publication
(10) Pub. No.: US 2019/0126206 A1
(43) Pub. Date: May 2, 2019

(54) MEMBRANE ARRANGEMENT

(71) Applicant: PLANSEE SE, REUTTE (AT)

(72) Inventor: MARKUS HAYDN, REUTTE (AT)

(21) Appl. No.: 16/312,465

(22) PCT Filed: Jun. 14, 2017
(86) PCT No.: PCT/AT2017/000048

§ 371 Date: Dec. 21, 2018

(30) Foreign Application Priority Data
Jun. 22, 2016 (AT) GM 152/2016

(51) Int. Cl. B01D 63/06; B01D 65/00; B01D 69/10; B01D 69/12; B01D 71/02; C01B 3/50

(52) U.S. Cl. CPC B01D 63/065; B01D 65/003; B01D 69/10; B01D 2313/13; B01D 71/022; C01B 3/505; B01D 2313/02; B01D 69/12

(57) ABSTRACT

A membrane arrangement for the permeative separation of a gas from gas mixtures has a porous, gas-permeable, metallic support substrate, a membrane formed on the support substrate and selectively permeable for the gas to be separated off. A ceramic, gas-permeable, porous, first intermediate layer is formed between the support substrate and the membrane and directly on the support substrate. A gastight, metallic coupling part is joined by a material-to-material bond to the support substrate. The support substrate and the coupling part are separated by a dividing line. The intermediate layer extends towards the coupling part over the gas-permeable surface of the porous support substrate at least to a distance of 2 mm from the dividing line and extends over the gastight surface of the coupling part by not more than 2 mm beyond the dividing line.

The present invention relates to a membrane arrangement for the permeative separation of a gas from gas mixtures. The invention further relates to a process for producing such a membrane arrangement.

Membrane arrangements of this type are generally used for the selective separation of a gas from gas mixtures, in particular for the separation of hydrogen from hydrogen-containing gas mixtures (e.g. steam-reformed natural gas). As is known, the property of particular materials that they are only selectively permeable for particular atoms or molecules (e.g. H₂) is exploited here in that they are used as a thin layer (“membrane”), e.g. as layer on a support or as self-supporting film, in order to divide off a gas space for the gas mixture from a gas space for the gas to be separated off. If, for example, a gas mixture having a particular partial pressure of the gas to be separated off, e.g. having a particular H₂ partial pressure, is introduced on one side of the membrane, the atoms/molecules of the gas to be separated off try to get through the membrane to the other side until the same partial pressure of the gas to be separated off prevails on both sides. The membrane area can be assigned a specific gas flux of the gas to be separated off, in particular a specific H₂ gas flux, as performance parameter. It is a general rule that the thinner the membrane and, at least in the case of metallic membranes, the higher the operating temperature, the higher is the specific gas flux of the gas to be separated off (e.g. H₂). For this reason, there is a need to use very thin membranes in order to keep the plant very small, and thus reduce the plant costs, at a desired gas flux. Since thin membranes in the region of a number of μm (microns) have very low dimensional stability and stiffness, they are frequently configured as a layer on a porous, gas-permeable, tubular or planar support substrate which ensures gas supply to and/or gas removal from the membrane and provides a flat surface for applying the membrane. Metallic materials for the support substrate display low production costs compared to ceramic materials and can be joined relatively easily to a metallic coupling part which is gastight at least on the surface, for example by welding or soldering.

Thus, integration of the membrane arrangement into a module (having a plurality of membrane arrangements of this type) or more generally into a plant within which the gas separation is carried out can be effected via the coupling part. A ceramic, gas-permeable, porous, first intermediate layer is frequently provided between the support substrate and the membrane in order to avoid diffusion effects and in many cases also to give a stepwise reduction of the pore size from the metallic support substrate to the membrane.

The transition from the porous support substrate via the material-to-material join (e.g. welding seam) to the dense, metallic surface of the coupling part presents a great challenge in the application of the abovementioned layers. In this transition region, gastight separation of the two gas spaces has to be ensured, at least as far as the further gases present in the gas mixture in addition to the gas to be separated off are concerned. However, due to the various transitions between materials, this transition region represents the mechanical weak point and spalling of the layers occurs time and again.

One variant for producing such an impermeable transition region is described in U.S. Pat. No. 8,753,433 B2. There, the membrane is drawn from the support substrate as far as over the coupling part and ends directly on the latter. The intermediate layer provided between support substrate and membrane extends as far as over the connecting region between support substrate and coupling part, but ends before the membrane in the direction of the coupling part. A membrane arrangement in which an impermeable layer extends in the transition region over a porous, ceramic support substrate and a gastight, ceramic coupling part and on which the membrane ends is described in JP 2014-046229 A.

It is an object of the present invention to provide a membrane arrangement of the abovementioned type and a process for producing such a membrane arrangement, in which the layer structure in the transition region between the support substrate and the coupling part remains joined over its area to the respective substrate over long periods of use.

The object is achieved by a membrane arrangement as claimed in claim 1 and by a process for producing a membrane arrangement as claimed in claim 14. Advantageous further embodiments of the invention are indicated in the dependent claims.

According to the present invention, a membrane arrangement for the permeative separation of a gas from gas mixtures (e.g. H₂ from H₂-containing gas mixtures) is provided (gas separation membrane arrangement). The membrane arrangement comprises a porous, gas-permeable, metallic support substrate, a membrane (gas separation membrane) which is formed on the support substrate and is selectively permeable for the gas to be separated off and a coupling part consisting at least on the surface of a gastight, metallic material, where the support substrate is joined by a material-to-material bond to the coupling part along a peripheral section of the support substrate. The gas-permeable surface of the support substrate is separated from the gastight surface of the coupling part by a dividing line. Between the support substrate and the membrane and arranged directly on the support substrate, there is a ceramic, gas-permeable, porous, first intermediate layer which extends on the gas-permeable surface of the porous support substrate in the direction of the coupling part at least to a distance of 2 mm from the dividing line and extends in the same direction on the gastight surface of the coupling part not more than a distance of 2 mm beyond the dividing line.

Where reference is made in this description and the claims to layers/components following one another “directly”, the presence of intermediate layers/components is ruled out. On the other hand, if the supplement “directly” is not used, it is possible, if technically feasible, for further layers/components to be additionally provided in-between. Where ranges are indicated, the limit values indicated are intended to be included in each case.

The terms “gastight” and “gas-permeable” refer to properties in respect of the further gases present in the gas mixture in addition to the gas to be separated off.

The structure of the membrane arrangement claimed is associated with a number of advantages which are explained below with reference to the functioning of the individual components. The term “membrane” is used to refer to a thin layer of a material which is selectively permeable for particular types of gas (in particular for H₂). Here, the membrane (or the material thereof) is selected according to the gas to be separated off (e.g. H₂). The further gases present in the respective gas mixture may also have to be taken into account in the design and selection of materials of the components of the membrane arrangement, for example if a component has to be made gastight for all of these gases of the gas mixture. The membrane can in principle be configured as a self-supporting film or as (at least one) layer on a support substrate. With a view to a very high performance parameter, a sheet-like support substrate is used for the membrane in the membrane arrangement of the invention in order for the membrane to be provided as thin layer thereon. The support substrate has to be porous and gas-permeable in order, depending on which side of the membrane the support substrate is used (in the case of a tubular construction preferably on the inside of the membrane), to ensure gas supply to or gas removal from the membrane. For the support substrate and therefore correspondingly also for the membrane applied thereto, there are two customary basic shapes, namely a planar basic shape and a tubular basic shape, with the focus being increasingly on the tubular basic shape. Both metallic and ceramic materials are used for the support substrate, with the metallic support substrate claimed in the present case distinguishing itself from ceramic support substrates in that it is cheaper to produce, easier to seal in the transition region to the coupling part and relatively easy to join to the coupling part, for example by means of a welding process, by means of soldering or by means of an adhesive bond. The production of such porous, gas-permeable, metallic support substrates is carried out, in particular, via a powder-metallurgical production process which comprises the steps of shaping (e.g. pressing) and sintering of metallic starting powders, giving porous support substrates having a microstructure typical of powder-metallurgical production. In this microstructure, the individual grains of the metal powder are discernible, with these individual grains being joined to one another by more or less pronounced sintering necks (discernible, for example, from an electron micrograph of a polished section), depending on the degree of sintering. However, porous, gas-permeable, metallic support substrates, in particular support substrates of this type produced by a powder-metallurgical route, have a relatively large pore size (sometimes up to 50 μm), which makes sealing to a membrane which typically has a thickness of only a few microns (thickness in the case of gas separation membranes is, in particular, in the range 5-15 μm) considerably more difficult. Suitable materials for the support substrate are, in particular, iron (Fe)-based alloys (i.e. containing at least 50% by weight, in particular at least 70% by weight, of Fe), having a high chromium (Cr) content (e.g. at least 16% by weight of Cr), to which further additives, e.g. yttrium oxide (Y₂O₃) (to increase the oxidation resistance), titanium (Ti) and molybdenum (Mo) can be added, with the total proportion of these additives preferably being less than 3% by weight (cf., for example, the material designated as ITM from Plansee SE containing 71.2% by weight of Fe, 26% by weight of Cr and a total of less than 3% by weight of Ti, Y₂O₃ and Mo). Furthermore, interdiffusion effects between the metallic support substrate and the membrane (which is normally also metallic for separating off H₂), which over time would lead to degradation or destruction of the membrane, occur at the high operating temperatures (typically operating temperatures in the gas separation in the range 450-900° C.). To avoid these disadvantages, at least one ceramic, gas-permeable, porous intermediate layer (e.g. composed of 8YSZ, i.e. zirconium oxide fully stabilized with 8 mol % of yttrium oxide (Y₂O₃)) is inserted between the support substrate and the membrane. It suppresses interdiffusion effects between the support substrate and the membrane. A further function of the intermediate layer is that it enables the pore size to be reduced, optionally stepwise (in particular by application of a plurality of intermediate layers, i.e. a “gradated layer structure”), to a few μm, in particular to an average pore size in the range 0.03-0.50 μm suitable for the concluding coating with the membrane.

The layer structure (support substrate with intermediate layer(s) and membrane) is to be connected to appropriate connection conduits of the plant (e.g. reactor) for gastight supply or discharge of the process gases. In order to achieve such gastight coupling of the layer structure to connection conduits, a coupling part consisting at least on the surface of a gastight, metallic material is provided directly adjacent to the support substrate. The support substrate is joined to the coupling part by material-to-material bonding (for example by means of a welded join, soldered join or adhesive join) along a peripheral section of the support substrate. This join can be reinforced by suitable positive and/or frictional connections of the coupling part with the support substrate. The coupling part is preferably a component made of solid metallic material which is joined by material-to-material bonding to the support substrate. In this case, the support substrate and the coupling part are components which have originally been two separate components. In the present patent application, material-to-material bonded components explicitly include an arrangement in which the support substrate and the coupling part are made in one piece and are thus made up of two imaginary components which are in material-to-material contact with one another. In this variant, the originally porous support substrate can be made gastight in the regions required as coupling part in an after-treatment step. This can, for example, be effected by means of pressing or by large-area surface melting in the required regions, for example by means of a laser beam, as a result of which the coupling part is made gastight at least on the surface. The gastight, metallic region of the coupling part is preferably located on the same side as the membrane on the adjoining support substrate, in the case of a tubular basic shape particularly on the outside.

It is common to the different embodiments of the coupling part and the support substrate that a gas-permeable area of the support substrate provided for gas separation is present on the support substrate, while at least the surface of the coupling part is gastight. The abutment of the gas-permeable surface and the gastight surface of the arrangement defines a dividing line (butt joint); surfaces having gastight weld seams or soldering points are to be assigned to the gastight surface.

The coupling part can perform further functions, e.g. the combining or division of a plurality of connection conduits. For this purpose, appropriately functionalized sections can be molded onto the coupling part and/or be joined to the latter. In the case of a tubular construction, the coupling part is, at least in the region adjoining the support substrate, also tubular and the material-to-material join extends around the entire circumference of the adjoining components.

The first intermediate layer (and optionally further intermediate layers) and the membrane extend essentially over the entire gas-permeable area of the support substrate provided for gas separation. In the case of a tubular construction, this corresponds to the cylindrical outer surface (or optionally the cylindrical inner surface) of the support substrate, with at least one axial peripheral region optionally being able to be provided with a recess (e.g. for attachment of a connection component or a sealing end part).

In the region of the layer structure, sealing (apart from the permeability for the gas to be separated off) is effected by the membrane.

The challenge addressed by the present invention is the gastight, at least in respect of the further gases present in the gas mixture in addition to the gas to be separated off (hereinafter: “further gases”), configuration of the transition region between the coupling part and the support substrate (the region around the dividing line). The key aspect of the present invention is that the first intermediate layer extends essentially over the entire gas-permeable area of the support substrate but not beyond this area, i.e. the first intermediate layer extends (apart from a manufacturing-related small gap) up to the dividing line in the direction of the coupling part, but not significantly beyond this dividing line. In quantified terms, this means that the first intermediate layer extends in the direction of the coupling part on the gas-permeable surface of the porous support substrate at least to a distance of 2 mm, in particular to a distance of 1 mm, particularly preferably to a distance of 0.5 mm, from the dividing line, while it extends in the same direction not more than a distance of 2 mm, preferably not more than a distance of 1 mm, particularly preferably not more than a distance of 0.5 mm, over the dividing line.

In other words, the first intermediate layer covers the entire gas-permeable surface of the support substrate, apart from a region having a maximum distance of 2 mm from the dividing line, and does not extend onto the gastight surface of the arrangement, except for a region having a maximum distance of 2 mm from the dividing line. The first intermediate layer is in direct contact with the support substrate. Direct contact of the first intermediate layer with the gastight surface, which is problematical because of lack of adhesion, is largely to completely avoided.

In particular, the membrane itself or, as an alternative, a layer which is gastight for the further or all gases of the gas mixture and adjoins the membrane or overlaps it, which is drawn out as far as over the coupling part and then lies directly on the coupling part and seals the latter in a gastight manner (for the further or all gases of the gas mixture), serves to effect sealing in the transition region.

The first intermediate layer advantageously has a smaller average pore size than the support substrate. In this way, the average pore size is reduced in the direction of the membrane and a smoother surface is provided for application of the membrane. The porosity of the first intermediate layer is in this case preferably at least 20%; owing to the small layer thickness and the usually angular shape of the individual ceramic particles, the determination of the porosity is associated with a relatively large measurement error. A preferred average particle size for the first intermediate layer is in the range from 0.20 μm inclusive to 2.00 μm inclusive, in particular in the range from 0.31 μm inclusive to 1.2 μm inclusive, more preferably in the range from 0.31 μm inclusive to 0.8 μm inclusive, if the membrane has been applied directly to the first intermediate layer and no further intermediate layers are provided for a stepped reduction of the porosity in the direction of the membrane. In this case, when no further intermediate layers are applied, the average pore size is particularly preferably less than 0.5 μm inclusive. In a further embodiment, the first intermediate layer has an average particle size in the range 0.7-3.5 μm, in particular in the range 0.76-2.5 μm, more preferably in the range 0.8-1.8 μm. In particular, the particle size distribution of the first intermediate layer is in the range from 0.01 to 100.00 μm. The further ranges for the average pore and particle sizes and also the corresponding size distributions and in particular the narrower ranges are selected firstly so as to achieve good adhesion of the first intermediate layer to the substrate, and secondly so as to produce a good transition to a possible second intermediate layer. The layer thickness of the first intermediate layer is, in a further embodiment, in the range 5-120 μm, in particular in the range 10-100 μm, more preferably in the range 20-80 μm. The layer thicknesses indicated for the first intermediate layer relate to the region of the support substrate having a largely constant layer thickness, while layer thickness fluctuations can occur in the transition region to the coupling part due to unevennesses. It has to be taken into account that the material of the first intermediate layer can partially soak into the support substrate.

In a preferred embodiment, at least one further ceramic, gas-permeable, porous, second intermediate layer which has a smaller average pore size and preferably a smaller average particle size than the first intermediate layer is arranged between the first intermediate layer and the membrane. This second intermediate layer preferably extends in the direction of the coupling part beyond the first intermediate layer and ends directly on the coupling part.

The invention is based on the recognition that the spalling of the layers which occurs in the transition region and leads to failure of the membrane arrangement is attributable to the following causes: between the first intermediate layer and the gastight surface of the coupling part, which has a comparatively low surface roughness and is, in particular, made of a solid metallic material (e.g. steel), there is only unsatisfactory adhesion. This also applies to the region of any material-to-material join (weld seam, soldering point) which likewise locally provides a smooth surface. Furthermore, different coefficients of thermal expansion of the materials used for the coupling part, the support substrate and the ceramic intermediate layer lead to stresses within the layer structure, in particular during sintering of the layer structure or later during use of the membrane arrangement. If cracks are formed within the first intermediate layer or spalling occurs as a result of these stresses, these defects propagate through the further layers of the layer structure and lead to failure of the membrane arrangement.

As a result of direct contact of the comparatively coarse-grained ceramic first intermediate layer with the gastight surface being largely to completely avoided in the membrane arrangement of the invention, the adhesion of the further layer(s) in the transition region can be significantly increased. Only the significantly denser membrane and, if further ceramic intermediate layers are present, these ceramic intermediate layers, which, however, have a lower porosity and preferably a smaller average particle size compared to the first intermediate layer, therefore come into direct contact with the comparatively smooth gastight surface of the coupling part. Owing to the finer ceramic particles of the second and optionally further intermediate layer(s) which come into direct contact with the metallic gastight surface of the arrangement, significantly more sintering necks are formed between the second (and optionally further) intermediate layer(s) and the underlying metallic gastight surface of the arrangement (in particular the material-to-material bond) during sintering than would be the case between the metallic gastight surface and the first intermediate layer. Since only layers having a relatively low porosity are in direct contact with the gastight, comparatively smooth surface, the adhesion of the layers in the transition region around the dividing line is thus significantly improved. The risk of occurrence of spalling, both during sintering during production and also in later use, is significantly reduced thereby.

The use of at least one second intermediate layer which has a lower porosity than the first intermediate layer and extends beyond the first intermediate layer brings about a number of advantages. As a result of the use of a second intermediate layer, the stress due to the different coefficients of thermal expansion is reduced. Furthermore, the second layer provides an additional diffusion barrier between support substrate and membrane and in particular closes a possible small production-related gap region on the gas-permeable surface of the support substrate in the transition region in the vicinity of the dividing line. As a further important advantage, a stepwise reduction in the average pore size from the support substrate through to the membrane is achieved, and a sufficiently smooth surface for application of the membrane is provided, by the use of a second intermediate layer having a reduced pore size and preferably a reduced particle size. Since ceramic materials generally adhere well to one another, in particular can be sintered to one another readily, the application of the second intermediate layer and, as set forth below, optionally further intermediate layers is unproblematical in this respect.

An average pore size in the range 0.03-0.50 μm, in particular in the range 0.03-0.30 μm, more preferably in the range 0.03-0.25 μm, has been found to be particularly advantageous for the second intermediate layer. In a further embodiment, the second intermediate layer has an average particle size in the range 0.01-1.00 μm, in particular in the range 0.01-0.75 μm, more preferably in the range 0.03-0.50 μm. In particular, the particle size distribution of the second intermediate layer is in the range from 0.01 to 25.00 μm. The layer thickness of the second intermediate layer is, in a further embodiment, in the range 5-75 μm, in particular in the range 5-50 μm, more preferably in the range 10-25 μm.

It has to be noted here that, in particular, the layer thickness of the second or further intermediate layers can vary in order to even out nonuniformity, e.g. in the transition region, for example at the periphery of the first intermediate layer, or in the region of a material-to-material bond, and provide a more uniform substrate for subsequent layers or the membrane. Thus, for example, the second intermediate layer or a further intermediate layer can become ever thinner in the direction of the peripheral region and stop or be, for example, thicker in the region of a welding seam. This improves adhesion of the layer structure and reduces the risk of crack formation. For this reason, a position in the region of the first intermediate layer having a sufficient distance from the transition region is selected as reference for the layer thickness. An additional layer (covering layer) can optionally be provided in the transition region, with this additional layer not extending over the entire gas-permeable area of the support substrate but only over the transition region. This additional layer likewise serves to even out any nonuniformity in the transition region.

In general, the second intermediate layer can directly adjoin the membrane. As indicated above, one or more further, ceramic, gas-permeable, porous intermediate layer(s) can, as an alternative, also be provided between the second intermediate layer and the membrane, in which case the average pore size of these further intermediate layer(s) preferably decreases still further from the second intermediate layer in the direction of the membrane. A layer structure graduated in this way allows even more uniform adjustment from the comparatively coarsely porous structure of the support substrate to the fine-pored structure as is required for the concluding coating with the membrane.

In a further embodiment, the average pore size of the second or further intermediate layer(s) deviates from the first intermediate layer or the directly underlying intermediate layer by at least 0.10 μm, in particular by at least 0.15 μm, preferably even by at least 0.20 μm, from the average pore size of the first intermediate layer or the directly underlying intermediate layer. The different porosity and the associated particle size promote good adhesion properties, avoid possible stresses and ensure that when the subsequent layer is applied in the manufacturing process this layer does not penetrate or soak too deeply into the previous layer.

In general, indications of layer thickness, indications in respect of the pore size and also indications in respect of the particle size in each case relate to these parameters in the ready-to-use state, i.e., in the case of layers to be sintered, to the sintered state. The various layers can be distinguished from one another in an electron micrograph of a polished section in cross section by means of the interfaces which generally form between the layers and are particularly pronounced in the case of layers which have been sintered layer by layer and by means of the differing pore size.

The pore size or pore length of an individual pore is determined as follows: the area of the respective pore in the polished section is measured and its equivalent diameter, which is that of a circle of the same area, is subsequently determined. The particle size is determined analogously. To determine the pore sizes and particle sizes, a cross section running perpendicularly to the layer to be examined through the membrane arrangement is produced and an appropriately prepared polished section is examined under a scanning electron microscope (SEM). The analysis is carried out via the threshold value of the various shades of grey from the respective SEM-BSE image (BSE: back scattered electrons). Here, the brightness and the contrast of the SEM-BSE image is set so that the pores and particles are readily recognizable and distinguishable from one another in the image. A suitable shade-of-grey value is selected as threshold value by means of the slider control which differentiates between pores and particles as a function of the shade of grey. To determine the average pore size, the pore size of all pores of a previously selected representative region of the layer concerned in the polished section is measured and the average thereof is subsequently calculated. The determination of the average particle size is carried out analogously. For the individual particle to be measured in each case, the geometric outline thereof is decisive rather than the grain boundaries of possibly a plurality of grains joined to form a particle, each having a different crystallographic orientation. Here, only the pores or particles which lie completely within the selected region are included in the evaluation. The porosity of a layer can be determined in the polished section (SEM-BSE image) by determining the proportion by area of the pores located within a selected region relative to the total area of this selected region, with the proportions by area of the pores which lie only partly within the selected region also being included. For the present purposes, the program Imagic ImageAccess (Version: 11 Release 12.1) with the analysis module “Particle Analysis” was used.

In a further embodiment, the first intermediate layer and optionally further intermediate layers provided is/are in each case (a) sintered, ceramic layer(s). A ceramic, sintered layer displays a typical microstructure in which the individual ceramic grains are discernible and are, depending on the degree of sintering, joined to one another by more or less strongly pronounced sintering necks (in the case of the present, ceramic, sintered layers, the sintering necks can also be only very weakly pronounced). The typical microstructure can, for example, be discerned via an electron micrograph of a polished section. The individual, ceramic layers are preferably each applied by a wet-chemical method (e.g. screen printing, wet powder coating, dip coating, etc.), in particular by dip coating in the case of a tubular basic shape, and sintered layer-by-layer. Sintering layer-by-layer can, for example, be recognized in an electron micrograph of a polished section of the sintered layer structure by the interfaces between the individual layers being more strongly pronounced than in the case of layers which were originally present in the green state and were all sintered in a joint sintering operation, since in the case of the latter production route the interfaces between the layers become more blurred due to diffusion effects.

In a further embodiment, the materials of the at least one intermediate layer are selected from the group consisting of the following materials:

a. zirconium oxide (ZrO₂) stabilized with yttrium oxide (Y₂O₃),

b. zirconium oxide (ZrO₂) stabilized with calcium oxide (CaO),

c. zirconium oxide (ZrO₂) stabilized with magnesium oxide (MgO), and

d. aluminum oxide (Al₂O₃).

Preference is given to a zirconium oxide stabilized with yttrium oxide (YSZ for short), in particular a zirconium oxide fully stabilized with 8 mol % of yttrium oxide (Y₂O₃) (8YSZ for short).

Preference is given to using the same starting substance and the same sintering process for the second intermediate layer and optionally further intermediate layers as for the first intermediate layer; the ceramic intermediate layers are therefore formed of one and the same material (or composition) in a preferred embodiment. As a result, comparable coefficients of thermal expansion are achieved and inexpensive production is made possible. Preference is given to YSZ, in particular 8YSZ. However, the individual layers can differ in terms of their microstructure, for example in terms of the average pore size, the average particle size and the porosity. Instead of fully stabilized zirconium oxide (e.g. addition of typically 8 mol % of yttrium oxide in the case of Y₂O₃ as stabilizer), it is also possible to use a partially stabilized zirconium oxide (e.g. addition of typically 3 mol % of yttrium oxide in the case of Y₂O₃ as stabilizer). Further possible stabilizers for zirconium oxide are cerium oxide (CeO₂), scandium oxide (ScO₃) or ytterbium oxide (YbO₃).

In a further embodiment, the support substrate and the coupling part are each tubular. Their cross section is preferably circular with a constant diameter along the axial direction. As an alternative, however, a cross section closed in a different way, for example an oval cross section, or a cross section which widens along the axial direction can be provided. A material-to-material bond can, for example, be formed by an integral structure of the coupling part and the support substrate, by means of a soldered join, by means of an adhesive bond or by means of a welded join. In a further embodiment, the material-to-material join is formed by a welded join which in the case of a tubular basic shape preferably extends around the entire circumference of the respective tubular peripheral section. A welded join can be produced cheaply in a reliable process. Owing to the porosity of the support substrate, a depression is typically formed in the region of the welded join. In a further advantageous embodiment, the material-to-material join is in the form of a soldered join which, in a manner analogous to the welded join, in the case of a tubular basic shape preferably extends around the entire circumference of the respective tubular peripheral section. The soldered join is likewise inexpensive and can be produced in a reliable process, and has the advantage over a welded join that the parts to be joined are not melted and for this reason no distortion and no shrinkage occurs. An adhesive bond is likewise very inexpensive and compared to the abovementioned material-to-material forms of bonding has the advantage that it can be produced at room temperature or comparatively low temperatures.

For separating off hydrogen, pure metals which have a certain permeability for hydrogen but represent a barrier for other atoms/molecules are in principle well suited as materials for the membrane. With a view to avoiding the formation of an oxide layer which would impair this selective permeability, preference is given to using noble metals, in particular palladium, palladium-containing alloys (especially those having more than 50% by weight of palladium), e.g. palladium-vanadium, palladium-gold, palladium-silver, palladium-copper, palladium-ruthenium or else palladium-containing composite membranes, for example with the layer sequence palladium, vanadium, palladium, for separating off hydrogen (H₂). In a further embodiment, the membrane is accordingly made of palladium or a palladium-based, metallic material (e.g. alloy, composite, etc.). The Pd content of such membranes is, in particular, at least 50% by weight, preferably at least 80% by weight. Preference is also given to the at least one intermediate layer being made of zirconium oxide (ZrO₂) stabilized with yttrium oxide (Y₂O₃), in particular made of 8YSZ. Furthermore, the support substrate and the coupling part are each preferably made of iron-based materials. These features of the various components are each advantageous on their own and in particular display advantageous effects in combination.

The present invention further relates to a process for producing a membrane arrangement for the permeative separation of a gas from gas mixtures, especially for the separation of H₂ from H₂-containing gas mixtures, which arrangement comprises a porous, gas-permeable, metallic support substrate and a coupling part which at least on the surface consists of a gastight, metallic material, where the support substrate is joined by a material-to-material bond to the coupling part along a peripheral section of the support substrate. The process comprises the following steps:
a. application of a ceramic first intermediate layer directly onto the gas-permeable surface of the porous support substrate, where the first intermediate layer extends in the direction of the coupling part over the gas-permeable surface of the porous support substrate at least to a distance of 2 mm from the dividing line and the first intermediate layer extends in the direction of the coupling part over the gastight surface of the coupling part not more than a distance of 2 mm beyond the dividing line
b. application of a membrane which is selectively permeable for the gas to be separated off onto the ceramic first intermediate layer, where the membrane extends in the direction of the coupling part beyond the first intermediate layer and ends directly on the coupling part.

In the process of the invention, essentially the entire gas-permeable surface of the support substrate is thus covered by the first intermediate layer. In a preferred variant, at least one ceramic, porous, gas-permeable second intermediate layer which has a smaller average pore size and preferably a smaller average particle size than the first intermediate layer is applied onto the first intermediate layer before application of the membrane. Essentially the same advantages as in the case of the above-described membrane arrangement according to the invention are achieved by the process of the invention. The further embodiments and variants described above can be realized analogously in the case of the process of the invention, with achievement of corresponding advantages. In the case of the at least one ceramic intermediate layer, application consists of, in particular, applying the intermediate layer containing an organic binder and ceramic particles by a wet-chemical method and then sintering the layer and only then applying the subsequent layer (optionally in a corresponding way). A lower viscosity than that of the first intermediate layer is preferably selected for the suspension of the second intermediate layer. The suspension used for the first intermediate layer has a high viscosity, as a result of which penetration (soaking) of the material of the first intermediate layer into the comparatively coarsely porous support substrate is largely prevented. The suspension of the second intermediate layer has a low viscosity so that the sintered layer adheres well to an impermeable surface or to nonuniform transitions.

Further advantages and useful aspects of the invention can be derived from the following description of working examples with reference to the accompanying figures.

The figures show:

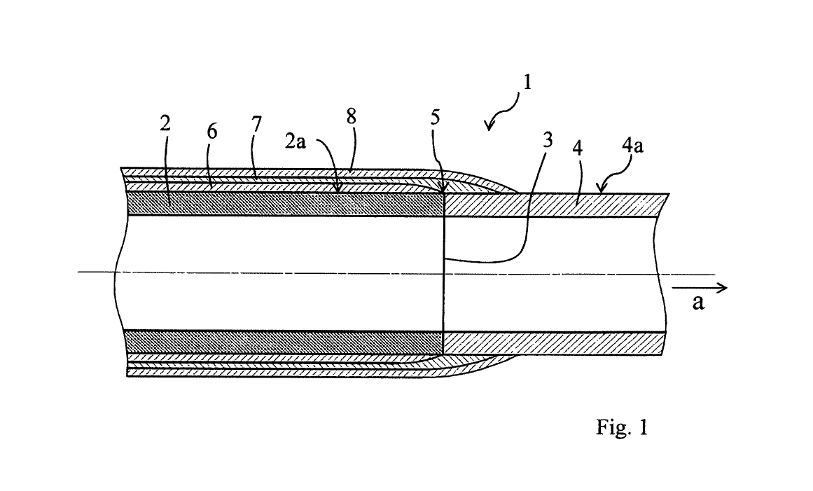

FIG. 1: a schematic cross-sectional view of a membrane arrangement according to the invention in the axial direction as per a first embodiment of the invention;

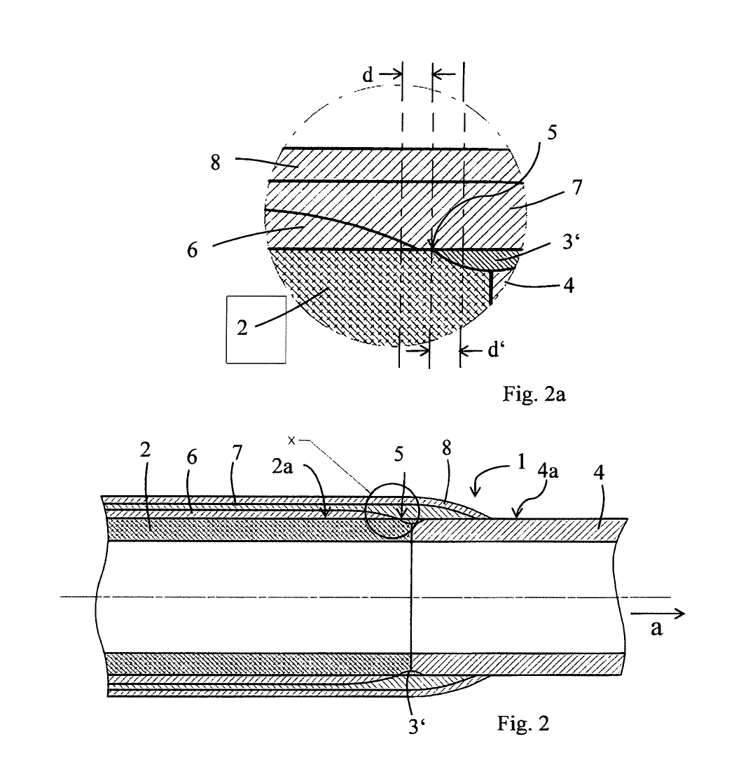

FIG. 2: a schematic cross-sectional view of a membrane arrangement according to the invention in the axial direction as per a second embodiment of the invention;

FIG. 2a: an enlarged section denoted by x of the membrane arrangement in FIG. 2;

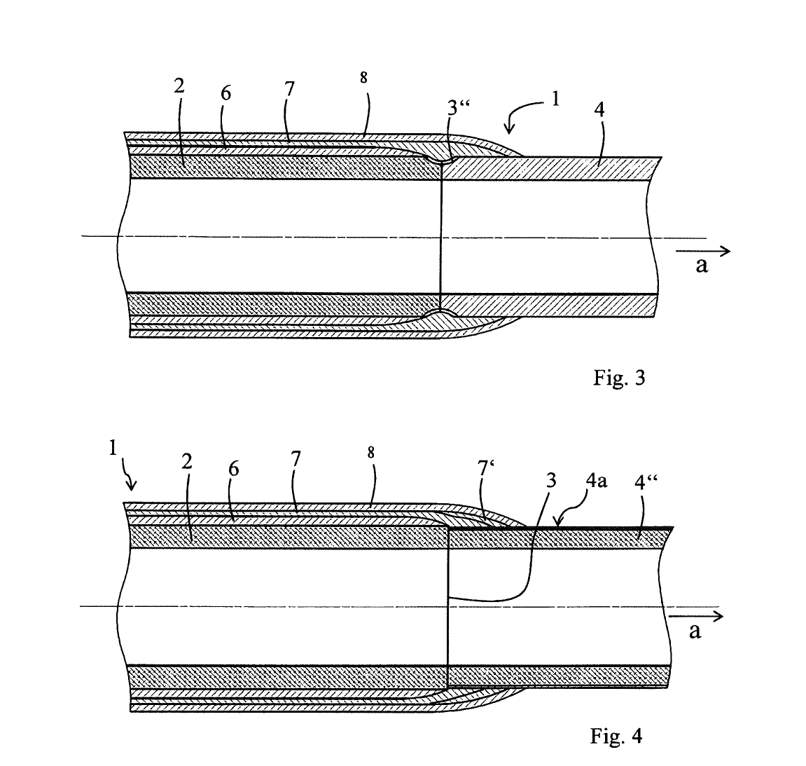

FIG. 3: a schematic cross-sectional view of a membrane arrangement according to the invention in the axial direction as per a third embodiment of the invention;

FIG. 4: a schematic cross-sectional view of a membrane arrangement according to the invention in the axial direction as per a fourth embodiment of the invention;

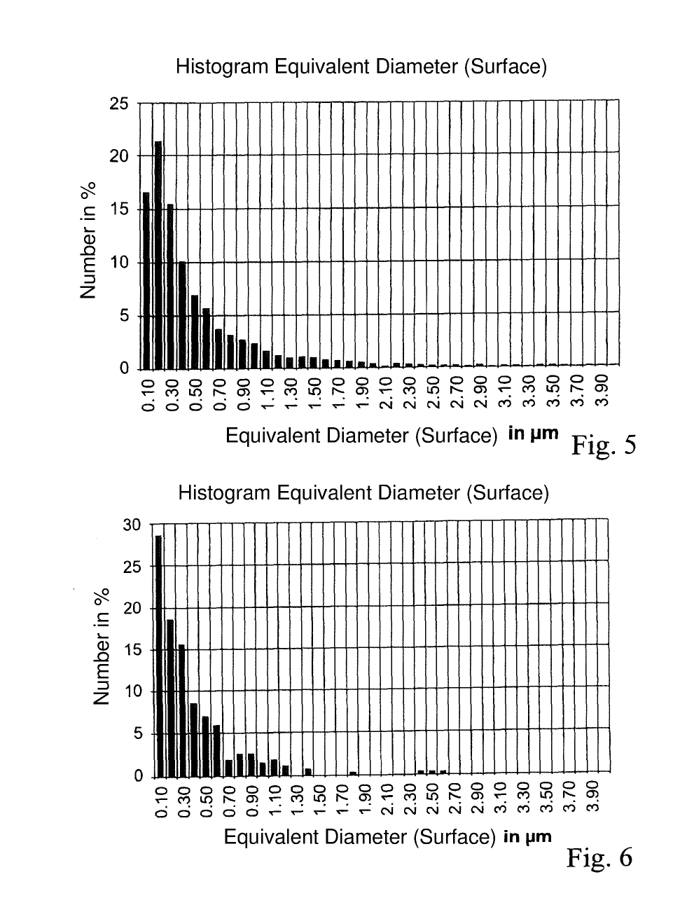

FIG. 5: pore size distribution of the first intermediate layer as per an embodiment of the invention;

FIG. 6: particle size distribution of the first intermediate layer as per an embodiment of the invention;

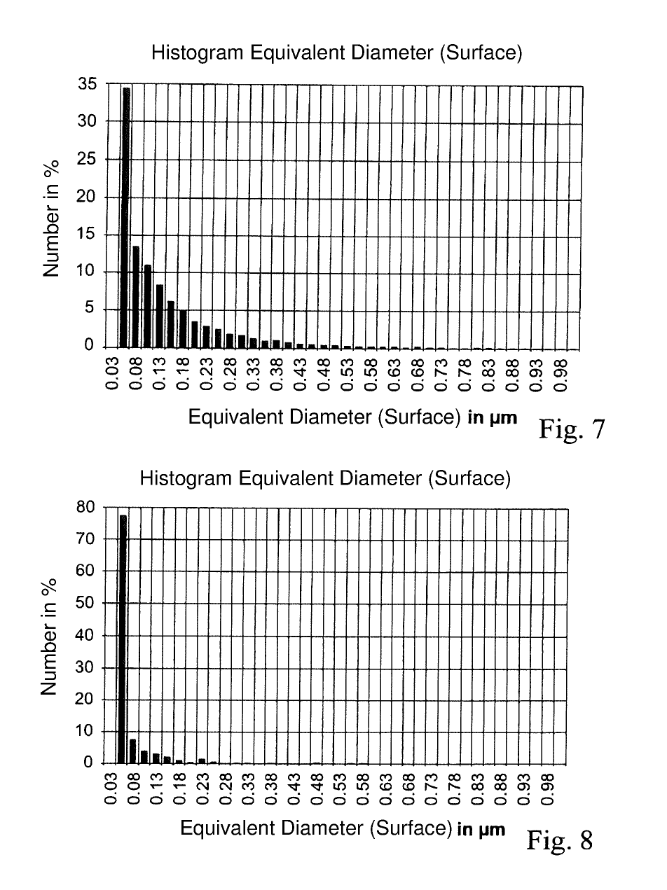

FIG. 7: pore size distribution of the second intermediate layer as per an embodiment of the invention; and

FIG. 8: particle size distribution of the second intermediate layer as per an embodiment of the invention.

FIGS. 1-4 show various embodiments, which differ from one another in terms of structure, of a membrane arrangement for the permeative separation of a gas to be separated off (e.g. H₂) from a gas mixture (e.g. steam-reformed natural gas containing CH₄, H₂O, CO₂, CO, H₂, etc.), with in each case only the transition region from the support substrate to the coupling part being depicted. In FIG. 1, a tubular, porous, gas-permeable, metallic support substrate 2 (e.g. made of ITM) is joined by a material-to-material bond 3 to a tubular coupling part 4 made of solid metal (e.g. steel) along the (circular) peripheral section of the support substrate. The gas-permeable surface of the support substrate 2a is separated by a dividing line 5 from the gastight surface of the coupling part 2b. A ceramic, gas-permeable, porous, first intermediate layer 6 (e.g. of sintered 8YSZ) is arranged directly on the support substrate and extends over the entire gas-permeable surface of the support substrate. This first intermediate layer has a smaller average pore size than the support substrate 2. A second ceramic, gas-permeable, porous intermediate layer 7 (e.g. of sintered 8YSZ) is arranged on top of this first intermediate layer 6. This second intermediate layer 7 has a smaller average pore size than the first intermediate layer; it extends beyond the first intermediate layer 6 and stops directly on the coupling part 4. Owing to its reduced average pore length compared to the first intermediate layer 6, it can provide a sufficiently smooth substrate for the subsequent membrane 8 (e.g. composed of Pd) which is selectively permeable for the gas to be separated off. The second intermediate layer is made somewhat thicker in the transition region in order to even out the nonuniformity at the periphery of the first intermediate layer and provide a more uniform substrate for the subsequent membrane 8. An additional layer 7′ can optionally be provided in the transition region, as depicted in the next working example in FIG. 4, and serves the same purpose, i.e. evening out any nonuniformities. The membrane 8 which directly adjoins the second intermediate layer extends in the direction of the coupling part (a) beyond the two intermediate layers 6 and 7 and stops directly on the coupling part 4 to which it produces a join which is gastight for the gas to be separated off (e.g. H₂).

In the following description of the second, third and fourth embodiments shown in FIGS. 2, 3 and 4, the same reference symbols are used for the same components. In the present description, only the differences compared to the first embodiment will be discussed. In the second embodiment (FIG. 2 and the enlarged section in FIG. 2a), the material-to-material join is realized by a soldered join 3′. The gas-permeable surface 2a of the support substrate merges continually into the gastight surface 4a of the coupling part, with the soldered join 3′ forming part of the gastight surface 4a. As shown in the enlarged depiction in FIG. 2a, the first intermediate layer 6 extends over the gas-permeable surface of the support substrate to the dividing line 5 but not beyond the latter. Due to the manufacturing, only a very small region on the gas-permeable surface of the support substrate around the dividing line 5 is not covered by the first intermediate layer 6. According to the invention, the maximum distance d on the gas-permeable surface of the support substrate which is not covered by the first intermediate layer 6 is less than 2 mm. In addition, it is common to all embodiments that the first intermediate layer 6 extends in the direction of the coupling part a over the gastight surface not more than a distance d′ of 2 mm beyond the dividing line 5. The connection to the coupling part 4 is effected by the second intermediate layer 7 which has a lower porosity, and therefore better adhesion properties, than the first intermediate layer 6 and provides a sufficiently smooth surface for application of the membrane.

In the third embodiment (FIG. 3), the material-to-material join is formed by a welded join 3″, with the welding process bringing about a circumferential depression because of the porosity. In a manner analogous to the second working example, direct contact of the first intermediate layer 6 with the smooth surface of the welding seam is avoided.

In the fourth embodiment (FIG. 4), the coupling part 4″ is made of a porous, gas-permeable base material, in particular the same material as the support substrate 2 (e.g. ITM), and has a gastight surface region 4a only on its exterior surface. The gastight surface region 4a can be produced, for example, by application of a coating or a sealing composition or by surface melting of the porous base material of the coupling part 4″. Here too, the first intermediate layer 6 does not extend (apart from an extremely small region around the dividing line) over the gastight surface 4a of the coupling part. The support substrate and the coupling part are preferably configured as an integral component.

In the following, an example of the production of a membrane arrangement according to the invention will be described. A support substrate in the form of a porous tube composed of ITM and having an external diameter of 5-10 mm, a length of 100-300 mm, a porosity of about 40% and an average pore size of <50 μm is at one of its axial ends welded to a tubular coupling part made of solid steel and having the same external diameter by laser welding. In order to ensure homogenization of the welded transition, the component obtained is annealed under a hydrogen atmosphere at a temperature of 1200° C. The surface in the region of the welded join is subsequently treated by sand blasting in order to achieve a more uniform surface. Next, the coupling part with the welded seam is covered. In a further step, a suspension suitable for a wet-chemical coating process, for example with addition of dispersant, solvent (e.g. BCA [2-(2-butoxyethoxy)ethyl] acetate, obtainable from Merck KGaA Darmstadt), and binder, is produced for the first intermediate layer produced from an 8YSZ powder, in particular a powder having a d80 of about 2 μm (and having a d50 of about 1 μm). The first intermediate layer is applied by dip coating, i.e. by dipping the tubular component into the suspension, up to the beginning of the welded seam. After drying, the covering of the gastight surface of the coupling part is removed and the component obtained is subsequently sintered under a hydrogen atmosphere at a temperature of 1300° C., as a result of which the organic constituents are burnt out, sintering of the ceramic layer takes place and the porous, sintered, ceramic first intermediate layer is obtained. A typical pore size distribution and particle size distribution of a first intermediate layer produced in this way are shown in FIGS. 5 and 6. In particular, the pore size distribution is in the range from 0.08 to 12.87 μm (with an average pore size of 0.55 μm), as can be seen from FIG. 5 (with a few pores having a larger diameter no longer being shown), and the particle size distribution is in the range 0.08-61.37 μm (with an average particle size of 1.27 μm), as can be seen from FIG. 6 (with a few particles having a larger diameter no longer being shown). In the next step, a suspension of 8YSZ powder for the second intermediate layer is prepared; the information given above for the first intermediate layer applies analogously, except that an 8YSZ powder that is finer overall is used and a somewhat lower viscosity of the suspension than for the first intermediate layer is set. In particular, a mixture or two 8YSZ powders having differing particle sizes, in particular a powder having a d80 of about 2 μm (and having a d50 of about 1 μm) and a very fine powder having a particle size (crystallite size) of about 25 nm (nanometers), is used as ceramic powder. The second intermediate layer is likewise applied by dip coating. The second intermediate layer covers the first intermediate layer completely and ends directly on the coupling part. Any nonuniformities in the transition region at the periphery of the first intermediate layer are evened out by application (brushing-on) of additional material. The component obtained is subsequently sintered under a hydrogen atmosphere at a temperature of 1200° C., as a result of which the organic constituents are burnt out, sintering of the ceramic layer takes place and the porous, sintered, ceramic second intermediate layer is obtained. The polished section of the second intermediate layer displays, in cross section, a homogeneous profile, even when the material of the second intermediate layer has been applied in a plurality of process steps (dip coating with subsequent brushing-on). A typical pore size distribution and particle size distribution of a second intermediate layer produced in this way are shown in FIGS. 7 and 8. In particular, the pore size distribution is in the range from 0.03 to 5.72 μm (with an average pore size of 0.13 μm), as can be seen from FIG. 7 (with a few pores having a larger diameter no longer being shown), and the particle size distribution is in the range from 0.03 to 18.87 μm (with an average particle size of 0.24 μm), as can be seen from FIG. 8 (with a few particles having a larger diameter no longer being shown). A Pd membrane is subsequently applied by means of a sputtering process. It completely covers the second intermediate layer and also the underlying first intermediate layer. Finally, a further Pd layer is applied electrolytically onto the sputtered Pd layer in order to seal the latter and achieve the required gastightness.

The present invention is not restricted to the embodiments depicted in the figures. In particular, the material-to-material join does not necessarily have to be realized as a welded join. For example, it can also be configured as a soldered join or adhesive bond. Furthermore, the coupling part and the support substrate can also have an integral or monolithic configuration, with the material-to-material join forming the transition between the gas-permeable support substrate and the coupling part which is gastight at least on the surface. For example, a monolithic configuration of the support substrate and the coupling part would also be possible in the fourth embodiment (FIG. 4). Furthermore, the structure described is suitable not only for separating off H₂ but also

for separating off other gases (e.g. CO₂, O₂, etc.). Alternative membranes can also be used, for example microporous, ceramic membranes (Al₂O₃, ZrO₂, SiO₂, TiO₂, zeolites, etc.) or dense, proton-conducting ceramics (SrCeO_{3-δ}, BaCeO_{3-δ}, etc.).

1-15. (canceled)

16. A membrane arrangement for permeatively separating off a gas from a gas mixture, the membrane arrangement comprising:
a porous, gas-permeable, metallic support substrate;
a membrane formed on said support substrate, said membrane being selectively permeable for the gas to be separated off;
a ceramic, gas-permeable, porous, first intermediate layer arranged between said support substrate and the membrane, and directly on said support substrate;
a coupling part joined by a material-to-material bond to said support substrate, said coupling part consisting, at least on a gastight surface thereof, of a gastight, metallic material, where said gas-permeable surface of said support substrate is separated from said coupling part by a dividing line;
said first intermediate layer extending over said gas-permeable surface of said porous support substrate in a direction of said coupling part at least to a distance of no more than 2 mm from said dividing line and said first intermediate layer extending in a direction of said coupling part over said gastight surface of said coupling part not more than by a distance of 2 mm beyond said dividing line.

17. The membrane arrangement according to claim 16, wherein said first intermediate layer has a smaller average pore size than said support substrate.

18. The membrane arrangement according to claim 16, wherein said first intermediate layer has an average pore size in a range from 0.20 μm inclusive to 2.00 μm inclusive.

19. The membrane arrangement according to claim 16, wherein at least one further ceramic, gas-permeable, porous, second intermediate layer which has a smaller average pore size than said first intermediate layer extends between said first intermediate layer and said membrane.

20. The membrane arrangement according to claim 16, wherein said second intermediate layer has an average pore size in a range from 0.03 μm inclusive to 0.5 μm inclusive.

21. The membrane arrangement according to claim 16, wherein said second intermediate layer extends in a direction of said coupling part beyond said first intermediate layer and ends directly on said coupling part.

22. The membrane arrangement according to claim 16, wherein at least one of said first intermediate layer or said second intermediate layer is a sintered, ceramic layer.

23. The membrane arrangement according to claim 16, wherein a material of said at least one intermediate layer is selected from the group consisting of:
zirconium oxide stabilized with yttrium oxide;
zirconium oxide stabilized with calcium oxide;
zirconium oxide stabilized with magnesium oxide; and
aluminum oxide.

24. The membrane arrangement according to claim 16, wherein said first intermediate layer and at least one said second intermediate layer are made of one and the same material.

25. The membrane arrangement according to claim 16, wherein each of said support substrate and said coupling part is tubular.

26. The membrane arrangement according to claim 16, wherein said material-to-material bond is a bond selected from the group consisting of a welded connection, a soldered connection and an adhesive connection.

27. The membrane arrangement according to claim 16, wherein said membrane extends in a direction of said coupling part beyond said at least one intermediate layer and ends directly on said coupling part.

28. The membrane arrangement according to claim 16, wherein:
said membrane is made of palladium or a palladium-based, metallic material; and
said at least one intermediate layer is made of zirconium oxide stabilized with yttrium oxide; and
said support substrate and said coupling part are made of iron-based materials.

29. A method of producing a membrane arrangement for the permeative separation of a gas from a gas mixture,
the arrangement including a porous, gas-permeable, metallic support substrate and a coupling part which at least on the surface consists of a gastight, metallic material;
the support substrate being joined by a material-to-material bond to the coupling part along a peripheral section of the support substrate and the gas-permeable surface of the support substrate being separated from the gastight surface of the coupling part by a dividing line;
the method comprising:
applying a ceramic first intermediate layer directly onto the gas-permeable surface of the porous support substrate, where the first intermediate layer extends in the direction of the coupling part over the gas-permeable surface of the porous support substrate at least to a distance of 2 mm from the dividing line and the first intermediate layer extends in the direction of the coupling part over the gastight surface of the coupling part not more than a distance of 2 mm beyond the dividing line; and
applying a membrane that is selectively permeable for the gas to be separated off onto the ceramic first intermediate layer, where the membrane extends in a direction of the coupling part beyond the first intermediate layer and ends directly on the coupling part.

30. The method according to claim 29, which comprises applying at least one ceramic, porous, gas-permeable second intermediate layer which has a smaller average pore size than the first intermediate layer onto the first intermediate layer before applying the membrane.
